(19) United States
(12) Patent Application Publication
(10) Pub. No.: US 2016/0010838 A1
(43) Pub. Date: Jan. 14, 2016

(54) LIGHTING SYSTEM

(71) Applicant: RSI Development LLC, Anaheim, CA (US)

(72) Inventors: John Du, Hacienda Heights, CA (US); Alexander G. Calabrese, Lemon Heights, CA (US)

(21) Appl. No.: 14/796,802

(22) Filed: Jul. 10, 2015

Related U.S. Application Data
(60) Provisional application No. 62/024,365, filed on Jul. 14, 2014.

(51) Int. Cl. F21V 23/02; H05B 37/02; F21V 23/00; B60Q 3/02

(52) U.S. Cl. CPC F21V 23/02; B60Q 3/0293; H05B 37/0209; F21V 23/001

(57) ABSTRACT

In one embodiment, a lighting system can include multiple fixtures and one AC to DC converter. The multiple fixtures can be mounted to an enclosure having an interior area. The multiple fixtures can each include an illumination source that illuminates the interior area. The one AC to DC converter can convert an AC signal received from a circuit breaker to a DC signal. The one AC to DC converter can be electrically connected to the plurality of fixtures via a plurality of wires and energize the illumination sources of the multiple fixtures with the DC signal. The illumination source of one fixture of the multiple fixtures can be separated by at least 3 Feet from the illumination source of another fixture of the multiple fixtures. The illumination sources of the multiple fixtures can provide in total at least 1400 Lumens.

### REFERENCE TO RELATED APPLICATIONS

The present application claims priority benefit under 35 U.S.C. §119 (e) from U.S. Provisional Patent Application No. 62/024,365, filed Jul. 14, 2014, entitled “DOWNLIGHTING SYSTEM,” the disclosure of which is incorporated herein by reference.

### BACKGROUND

The present disclosure is generally related to a lighting system.

### SUMMARY

In some embodiments, a downlighting system includes a plurality of illumination sources and at least one transformer driver electrically connected to the plurality of illumination sources, the transformer driver being electrically connected to a circuit breaker, wherein the plurality of illumination sources are connected to the circuit breaker through the transformer driver.

The downlighting system of the preceding paragraph can include one or more of the following features: The downlighting system can further include a light switch, wherein at least some of the plurality of illumination sources are electrically connected to the light switch, and the light switch is electrically connected to the at least one transformer driver, the light switch being configured to operate the at least some of the plurality of illumination sources. The downlighting system can further include a plurality of light switches, wherein each of the illuminations sources is electrically connected to at least one of the plurality of light switches, the plurality of light switches being electrically connected to the at least one transformer driver, and the plurality of light switches being configured to operate the plurality of illumination sources. The downlighting system can further include a plurality of transformer drivers. The at least one transformer driver can be configured to output 24 Volts DC. The plurality of illumination sources can include LEDs. The LEDs can be 14 to 20 Volts LEDs.

In some embodiments, a building has a downlighting system that includes a plurality of illumination sources and at least one transformer driver electrically connected to the plurality of illumination sources, the at least one transformer driver being electrically connected to a circuit breaker, wherein the plurality of illumination sources are connected to the circuit breaker through the at least one transformer driver.

The downlighting system of the preceding paragraph can include one or more of the following features: The building can further include a light switch, wherein at least some of the plurality of illumination sources are electrically connected to the light switch, and the light switch is electrically connected to the at least one transformer driver, the light switch being configured to operate the at least some of the plurality of illumination sources. The building can further include a plurality of light switches, wherein each of the illuminations sources is electrically connected to at least one of the plurality of light switches, the plurality of light switches being electrically connected to the at least one transformer driver, and the plurality of light switches being configured to operate the plurality of illumination sources. The building can further include a plurality of transformer drivers. The at least one transformer driver can be configured to output 24V DC. The plurality of illumination sources can include LEDs. The LEDs can be 14 to 20 Volts LEDs. The building can include a plurality of rooms, each of the rooms having a transformer driver connected to a plurality of illumination sources in the room. The plurality of rooms can be located on at least two floors of the building. The at least two of the rooms can be located greater than 50 feet away from one another. Each of the illumination sources can be located on its own fixture.

In some embodiments, a room of a building includes a plurality of illumination sources and a transformer driver electrically connected to the plurality of illumination sources through a plurality of wires containing low voltage, the transformer driver being electrically connected to a circuit breaker through a wire containing high voltage, wherein the plurality of illumination sources are connected to the circuit breaker through the transformer driver. The transformer driver can be located at least 50 feet from the circuit breaker.

In some embodiments, a vehicle has a downlighting system including a plurality of illumination sources and at least one transformer driver electrically connected to the plurality of illumination sources, the at least one transformer driver being electrically connected to a circuit breaker, wherein the plurality of illumination sources are connected to the circuit breaker through the at least one transformer driver.

The vehicle of the preceding paragraph can include one or more of the following features: The at least one transformer driver can be configured to output 24V DC. The plurality of illumination sources can include LEDs. The LEDs can be 14 to 20 Volts LEDs. The vehicle can further include a plurality of transformer drivers.

In some embodiments, a lighting system includes multiple fixtures and one alternating current (AC) to direct current (DC) converter. The multiple fixtures can be mounted to an enclosure having an interior area. The multiple fixtures can each include an illumination source that illuminates the interior area. The enclosure can include a ceiling, a floor, and a plurality of walls defining outer boundaries of the interior area. The one AC to DC converter can convert an AC signal received from a circuit breaker to a DC signal. The one AC to DC converter can be electrically connected to the multiple fixtures via multiple wires and energize the illumination sources of the multiple fixtures with the DC signal. The illumination source of one fixture of the multiple fixtures can be separated by at least 3 Feet from the illumination source of another fixture of the multiple fixtures. The illumination sources of the multiple fixtures can provide in total at least 1400 Lumens.

The lighting system of the preceding paragraph can include one or more of the following features: The AC signal can be 120 Volts AC or 110 Volts AC, and the DC signal can be between 18 Volts DC and 32 Volts DC. The one AC to DC converter can include one transformer that operates at 150 Watts. The enclosure can be a first room of a building, and the interior area can have a floor area of at least 1000 Feet. The one AC to DC converter can be positioned in a second room of the building different from the first room. The multiple wires can be positioned at least in part within the ceiling, and the multiple fixtures can be mounted to the ceiling and include metal frames that position the illumination sources of the multiple fixtures to illuminate towards the floor. The one AC to DC converter can be electrically connected to the circuit breaker via a second wire positioned at least in part within at least of one the ceiling, the floor, and the plurality of walls. The lighting system can further include a switch that activates and deactivates the illumination sources of one or more of the multiple fixtures. The illumination source of at least one of the multiple fixtures can provide at least 700 Lumens. The illumination source of at least one of the multiple fixtures can illuminate at a color temperature between 2700 Kelvin and 6000 Kelvin. The multiple fixtures can be positioned within 60 Feet from the one AC to DC converter. At least one of the multiple fixtures can be positioned at least 10 Feet from the one AC to DC converter. The one AC to DC converter can be positioned at least 50 Feet from the circuit breaker.

In some embodiments, a lighting system can include a first fixture, a second fixture, and one AC to DC converter. The first fixture can be mounted to a first enclosure having a first interior area. The first fixture can include a first illumination source that illuminates the first interior area. The first enclosure can include a first ceiling, a first floor, and a plurality of first walls defining outer boundaries of the first interior area. The second fixture can be mounted to a second enclosure having a second interior area. The second fixture can include a second illumination source that illuminates the second interior area. The second enclosure can include a second ceiling, a second floor, and a plurality of second walls defining outer boundaries of the second interior area. The one AC to DC converter can convert an AC signal received from a circuit breaker to a DC signal. The one AC to DC converter can be electrically connected to the first fixture and the second fixture via wires and energize the first illumination source and the second illumination source with the DC signal. The first enclosure can be a first room and the second enclosure can be a second room different from the first room. The first illumination source and the second illumination source can each provide at least 660 Lumens.

The lighting system of the preceding paragraph can include one or more of the following features: The first room and the second room can be on different floors of a common building. The first room and the second room can be separated by more than 50 Feet. The first room can be in a first building and the second room can be in a second building different from the first building. The AC signal can be 120 Volts AC or 110 Volts AC and the DC signal can be between 18 Volts DC and 32 Volts DC, and the one AC to DC converter can include one transformer configured to operate at 150 Watts. The wires can be positioned at least in part within the first ceiling, and the first fixture can be mounted to the first ceiling and include a metal frame that positions the first illumination source to illuminate towards the first floor.

In some embodiments, a system includes a vehicle and a lighting system. The vehicle can travel (for example, driver or be driven) on a roadway. The lighting system can include fixtures and one AC to DC converter. The fixtures can be mounted to a ceiling of an interior area of the vehicle. The fixtures can each include an illumination source that illuminates the interior area. The one AC to DC converter can convert an AC signal received from a circuit breaker to a DC signal. The one AC to DC converter can be electrically connected to the fixtures via wires and energize the illumination sources of the fixtures with the DC signal. The illumination source of one of the fixtures can be separated by at least 2 Feet from the illumination source of another of the fixtures, and the illumination source of at least one of the fixtures can provide at least 660 Lumens.

Some embodiments disclosed herein also include a method of operating any of the lighting systems described herein, such as any of the lighting systems described in the preceding five paragraphs.

### BRIEF DESCRIPTION OF THE DRAWINGS

FIG. 1A illustrates an example lighting system including a single alternating current (AC) to direct currently (DC) converter.

FIG. 1B illustrates a lighting system including multiple AC to DC converters.

FIG. 2A illustrates an example building with a lighting system like the lighting system of FIG. 1B.

FIG. 2B illustrates example multiple buildings with a lighting system like the lighting system of FIG. 1B.

FIG. 3 illustrates an example light fixture.

### DETAILED DESCRIPTION

A lighting system can be used to operate a plurality of illumination sources (for example, lights). The lighting system can include a remote alternating current (AC) to direct current (DC) converter, which can provide advantages over other lighting systems. For example, the disclosed lighting system can, in certain embodiments, reduce the amount of wiring required when installing illumination sources. Further, the disclosed lighting system can, in certain embodiments, provide for significant energy savings. While the below description describes a lighting system in the context of a building, the lighting system is not so limited and can be used, for example, outdoors, such as in recreational vehicles like camper vans.

In lighting systems, electrical energy (for example, mains power) can be brought into a building via one or more wires from the outside and enter a circuit breaker, such as at a voltage of around 70, 80, 90, 100, 110, or 120 Volts. The circuit breaker can then control and transfer the electrical energy via one or more other wires so that the electrical energy can pass to different locations of the building.

The electrical energy can proceed from the circuit breaker to switches for lights. While the electrical energy may proceed through junction boxes, or other general electrical equipment, the voltage of the electrical energy that passes into the switches and lights from the circuit break may remain the same as the voltage of the electrical energy that was received from the outside (for example, mains power). Accordingly, in some lighting systems, the switches and lights receive the same voltage as was received at the circuit breaker, which can be considered a relatively high voltage. Therefore, because the voltage at the lights and switches remains relatively high until right before the lights and switches, a person performing maintenance or replacing light bulbs of the lights or the switches has the potential to be seriously shocked and injured while working on such lights or switches.

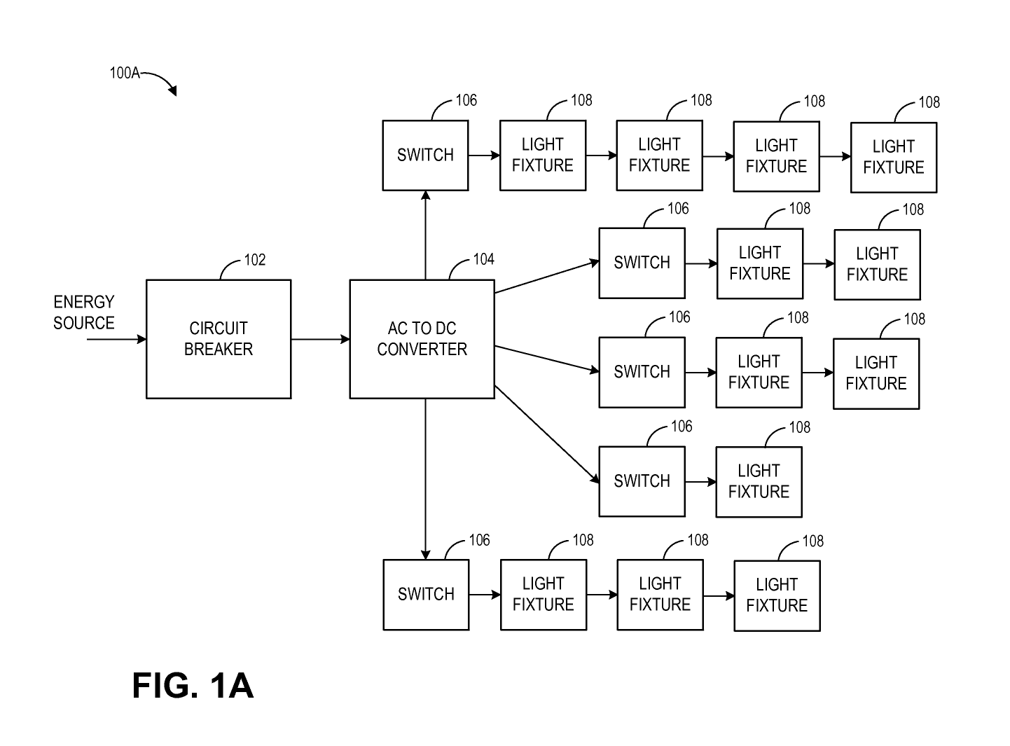

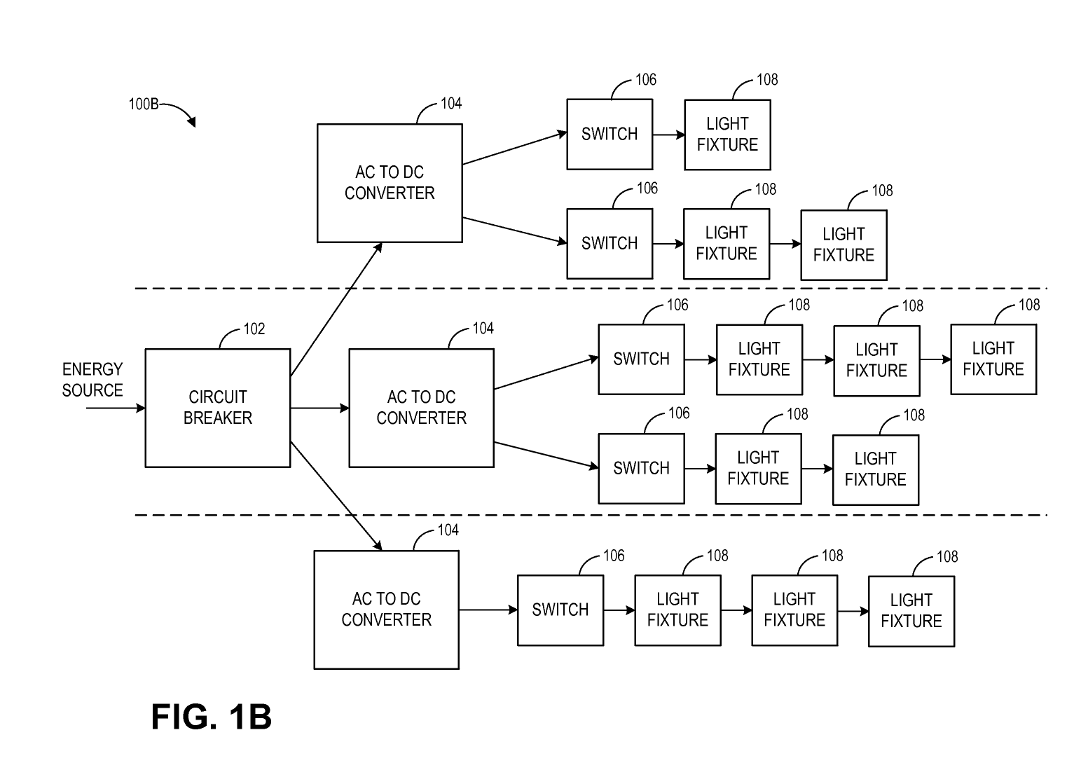

FIG. 1A illustrates a lighting system 100A that includes a single AC to DC converter separated from a circuit breaker. As shown, electrical energy can be provided from an outside energy source. For instance, the electrical energy can be brought into a building from outside the building, such as mains power at approximately 120 Volts or 110 Volts. The electrical energy can be communicated to a circuit breaker 102, which can control and further transmit the electrical energy. The circuit breaker 102 can then transfer the electrical energy from the circuit breaker 102 to an AC to DC converter 104 via one or more wires, such as a single cable including a hot wire, a neutral wire, and a ground wire).

The AC to DC converter 104 can be located in a different position from the circuit breaker 102. For example, AC to DC converter 104 can be located in a different room, on a different floor, or in a different building, and the location of the AC to DC converter 104 does not limit the disclosure. In some embodiments, the AC to DC converter 104 can be located greater than about 10, 25, 50, 75, 100, 150, or 200 feet from the circuit breaker 102. The AC to DC converter 104 can convert received electrical energy from AC to DC and, in some embodiments, output a DC voltage that may be less than the root mean square (RMS) voltage level of the received AC voltage. The AC to DC converter 104 can, for instance, include one or more transformers that reduce a voltage level of the DC output voltage relative to the RMS of the AC input voltage. The AC to DC converter 104 can provide the electrical energy via one or more wires to different lighting areas. As a result, the one or more wires of the lighting system 100A supplying DC electrical energy can extend from the AC to DC converter 104 to switches 106 and light fixtures 108, and the one or more wires of the lighting system 100A supplying AC electrical energy can extend from the circuit breaker 102 to the AC to DC converter 104.

Accordingly, the AC to DC converter 104 can, in some respects, become a second circuit breaker controlling the lighting system 100A. The AC to DC converter 104 can be located in any desired location, such as in a building like as within a garage or closet of the building, and can, in certain embodiments, allow for relatively easier wiring as the one or more relatively high voltage AC wires supplying power from the circuit breaker 102 may be electrically connected to the AC to DC converter 104, and the one or more relatively low voltage DC wires supplying power from the AC to DC converter 104 may be electrically connected to the switches 106 and the light fixtures 108. This can be especially advantageous, in certain embodiments, for larger buildings where the switches 106 and the light fixtures 108 can be relatively far away from the circuit breaker 102.

The switches 106 can activate and deactivate one or more illumination sources of the light fixtures 108. For example, as illustrated in FIG. 1A, one switch 106 can enable a person to selectively activate and deactivate the one or more illumination sources of a series of the one or more light fixtures 108 electrically connected to receive electrical energy from the one switch 106. In some embodiments, the switches 106 may not be included in the lighting system 100A or can be incorporated as part of the light fixtures 108 rather than being separate components from the light fixtures 108.

Advantageously, the lighting system 100A can, in certain embodiments, significantly reduce the amount of wiring using in a building, because the AC to DC converter 104 can be located in a centralized area around the switches 106 and the light fixtures 108, such as for instance in a garage or closet of the building. In one implementation, one AC current supplying wire can extend from the circuit breaker 102 to the AC to DC converter 104 and multiple DC current supplying wires can then extend from the AC to DC converter 104 to the switches 106 and light fixtures 108 and multiple AC current supplying wires may not extend directly from the circuit breaker 102 to each of the switches 106 and the light fixtures 108. The reduction of wiring can advantageously, in certain embodiments, allow for less electrical energy loss in the wirings (for example, through heat), thus reducing overall energy costs of operating the lighting system 100A.

In some embodiments, the lighting system 100A can reduce the total length of high voltage (for example, 120 Volts AC or 110 Volts AC) wiring in a building by 1, 5, 10, 15, 20, 25, or 50% as compared to a building in which illumination sources directly supplied AC voltage by a circuit breaker. In some embodiments, the lighting system 100A can reduce the total length of high voltage wiring in a building by greater than 1, 5, 10, 15, 20, 25, or 50% as compared to a building in which illumination sources directly supplied AC voltage by a circuit breaker. In some embodiments, the lighting system can result in the proportion of the total length of high voltage wiring to low voltage (for example, 18 Volts DC to 32 Volts DC) wiring in a building to be less than 1 to 1, 9 to 10, 8 to 10, 7 to 10, 6 to 10, 5 to 10, 4 to 10, 3 to 10, 20 to 10 or 1 to 10. In some embodiments, the lighting system 100A can result in the proportion of the total number of high voltage circuits to low voltage circuits in a building to be less than 1 to 1, 9 to 10, 8 to 10, 7 to 10, 6 to 10, 5 to 10, 4 to 10, 3 to 10, 20 to 10 or 1 to 10.

The lighting system 100A can promote energy savings over other lighting systems. For example, the lighting system 100A can have an energy savings of about 75, 80, 82, 85, 88, 90, or 95% over certain traditional 2-65 Watts incandescent lighting systems. Further, the lighting system 100A can have light quality improvement of about 150, 200, 250, 300, 350, or 400% over certain incandescent light systems.

Further, by using the AC to DC converter 104, the voltage in the lighting system 100A can be reduced significantly before the switches 106 and the light fixtures 108, and therefore before the one or more lights of the light fixtures 108. Accordingly, if any replacements or fixes may be performed to the lighting system 100A at the switches 106 and the light fixtures 108, the reduced voltage will reduce a danger from contact with the electrical energy at the switches 106 and the light fixtures 108 to a person working on the lighting system 100A. This can be different from other lighting systems, where a person may receive electrical energy at 120 Volts while working on all points of the other lighting systems. In some embodiments, a building using the lighting system 100A can be considered a “100% low voltage” lighting system. In some embodiments, a voltage below 48 Volts DC can be considered low voltage.

In some embodiments, the AC to DC converter 104 can include a transformer that operates at about 150, 170, 185, 200, 225, 250, 300, 350, 400, 500, 750, 1000, 1500, 2000, 3000, 4000, 5000, 7500, or 10k Watts. In some embodiments, the AC to DC converter 104 can include a transformer that operates at greater than about 150, 170, 185, 200, 225, 250, 300, 350, 400, 500, 750, 1000, 1500, 2000, 3000, 4000, 5000, 7500, or 10k Watts. This can be a higher wattage than may be used if an individual transformer is used to power each of the light fixtures 108. By using a single higher wattage transformer within the AC to DC converter 104 to power each of the light fixtures 108 rather than individual lower wattage transformers to power each of the light fixtures 108, the wattage loss can, in certain embodiments, be lower because using the single higher wattage rather than the individual lower wattage transformers can result in a greater energy efficiency.

In some embodiments, the AC to DC converter 104 can include a transformer located within a housing. The housing around the transformer can be hot potted according to IP67 or IP65 standards, which are both hereby incorporated by reference in their entirety. The transformer can be positioned inside an Underwriters Laboratory (“UL”) junction metal box.

The AC to DC converter 104 can convert the voltage received from the circuit breaker 102 into the lower voltage used for the one or more lights of the light fixtures 108. In some embodiments, the AC to DC converter 104 can convert the voltage from 120 Volts or 110 Volts, which is typically the power provided into a building such as from mains power, into a different voltage, such as a lower voltage. The AC to DC converter 104 can convert the voltage to about 18, 20, 22, 24, 26, 28, 30, or 32 Volts DC. In some embodiments, the AC to DC converter 104 can convert the voltage to greater than about 18, 20, 22, 24, 26, 28, 30, or 32 Volts DC. In some embodiments, the AC to DC converter 104 can convert the voltage to less than about 18, 20, 22, 24, 26, 28, 30, or 32 Volts DC. However, the output voltage of the AC to DC converter 104 does not limit the disclosure, and any desired output voltage can be produced to be used, for instance, with different lights.

In some embodiments, the AC to DC converter 104 can be used to operate about 10, 15, 20, 25, 30, 35 or 40 12 Watt, 24 Volts DC lights. In some embodiments, the AC to DC converter 104 can operate greater than about 10, 15, 20, 25, 30, 35 or 40 12 Watts, 24 Volts DC lights. The number of lights operated by the AC to DC converter 104 does not limit the disclosure.

Illuminations sources can be used in the light fixtures 108 of the lighting system 100A. For example, one, two, three, or four illumination sources can be included in one light fixture 108. In some embodiments, low voltage illumination sources can be used in the light fixtures 108 of the lighting system 100A. In some embodiments, the illumination sources can be LEDs, though the type of illumination source does not limit the disclosure. For example, one or more of the illumination sources can be a 6, 7, 7.82, 8, 9, 10, 11, 12, 13, 14, 15, 16, 17, 18, 19, or 20 Watts LED. In some embodiments, one or more of the illumination sources can be a greater than 6, 7, 7.82, 8, 9, 10, 11, 12, 13, 14, 15, 16, 17, 18, 19, or 20 Watts LED. In some embodiments, one or more of the illumination sources can be a less than 6, 7, 7.82, 8, 9, 10, 11, 12, 13, 14, 15, 16, 17, 18, 19, or 20 Watts LED. In some embodiments, one or more of the illumination sources can each be powered by about 18, 20, 22, 24, 26, 28, 30, or 32 Volts DC, and can match the output voltage of the AC to DC converter 104. In some embodiments, one or more of the illumination sources can each produce an amount of light equivalent to a 1, 2, 3, 4, or 5 65 Watts incandescent light. In some embodiments, one or more of the illumination sources can each produce about 660, 700, 740, 780, 820, or 840 Lumens. In some embodiments, one or more of the illumination sources can each produce greater than about 660, 700, 740, 780, 820, or 840 Lumens. However, the type and wattage of the illumination sources does not limit the disclosure.

In some embodiments, two or more of the illumination sources can be separated from one another. For example, in some embodiments, two or more of the illumination sources are not located a single light fixture. In one implementation, one or more of the illumination sources can be on separate light fixtures from one or more other illumination sources. Therefore, the AC to DC converter 104 can provide power to multiple fixtures 108, such as in a building. The light fixtures 108 or the illumination sources of the light fixtures 108 can each be separated about 1, 2, 3, 4, 5, 6, 7, 8, 9, 10, 15, or 20 Feet from one another. In some embodiments, the light fixtures 108 or the illumination sources of the light fixtures 108 can each be separated by greater than about 1, 2, 3, 4, 5, 6, 7, 8, 9, 10, 15, or 20 Feet from one another.

In some embodiments, the light fixtures 108 can be separated from the AC to DC converter 104 by less than about 25, 30, 35, 40, 45, 50, 55, 60, 70, 80, 100, 120, 150, or 200 Feet. Because the voltage may tend to decrease across the length of a wire connecting the AC to DC converter 104 to the light fixtures 108 due to the internal resistance in the wire, the length of the wires connecting the AC to DC converter 104 to the light fixtures 108 can be within a certain length to ensure proper functioning of the light fixtures 108. The one or more wires used to electrically connect the AC to DC converter 104 to the light fixtures 108 can be about 14 or 16 American wire gauge (AWG) in some implementations. In some embodiments, one or more of the light fixtures 108 can be separated from the AC to DC converter 104 by at least about 2, 3, 5, 8, 10, 12, 15, 20, 25, 30, 35, 40, 45, 50, 55, 60, 70, 80, 100, 120, 150, or 200 Feet. In some embodiments, one or more of the light fixtures 108 can be separated from the AC to DC converter 104 by between about 2 and 5 Feet, 3 and 10 Feet, 5 and 15 Feet, 10 and 20 Feet, 15 and 30 Feet, 20 and 40 Feet, 25 and 50 Feet, 30 and 60 Feet, 35 and 75 Feet, 40 and 90 Feet, or 45 and 100 Feet.

FIG. 1B illustrates a lighting system 100B. Similar to the lighting system 100A shown in FIG. 1A, FIG. 1B shows the AC to DC converters 104 used as intermediaries between the circuit breaker 102 and the switches 106 and the light fixtures 108. However, as shown in FIG. 1B, multiple AC to DC converters 104 can be used in the illustrated configuration. This shows that the AC to DC converters 104 can be used at different locations (for example, as indicated by the horizontal lines in FIG. 1B), while still reducing the overall amount of wiring that may go to the circuit breaker 102. For example, one AC to DC converter 104 can provide power for the 2^{nd} floor of a building, another AC to DC converter 104 can provide power for the 1^{st} floor of the building, and yet another AC to DC converter 104 can provide power for a basement of the building. However, this configuration does not limit the disclosure. For example, the three AC to DC converters 104 can be located on one floor of a building and can supply power to different sections of the building as desired. In some embodiments, the AC to DC converters 104 can supply power to multiple floors. In some embodiments, the AC to DC converters 104 can supply power to multiple buildings such as, for example, a garage separated from a main building.

In some embodiments, one or more of the AC to DC converters 104 can be spaced away from the circuit breaker 104, and away from one or more of the other AC to DC converters 104. For example, one or more of the AC to DC converters 104 can be located in different rooms in a building. In some embodiments, each room has a separate AC to DC converter 104. In some embodiments, the AC to DC converters 104 can power illumination sources in a plurality of rooms.

In some embodiments, the AC to DC converters 104 can be spaced at least about 10, 25, 50, 75, 100, 150, or 200 Feet from the circuit breaker 102. In some embodiments, one or more of the AC to DC converters 104 can be spaced at least about 10, 25, 50, 75, 100, 150, or 200 feet from one or more other AC to DC converters 104.

The lighting systems 100A and 100B can also be used in vehicles, such as campers and recreational vehicles. The electrical energy used for powering the lighting of the vehicles can be received, for example, from the vehicle battery or an outside generator, and the production of electricity does not limit the disclosure. One or more converters of the lighting systems 100A and 100B can be used to lower the voltage from the received electricity source, and supply the electrical energy to lights within the vehicle. The one of the converters, in some implementations, can be an AC to AC converter, a DC to DC converter, or a DC to AC converter rather than an AC to DC converter. As mentioned above, this can be advantageous for many reasons, in certain embodiments, including the reduction of shock harm to persons working on the switches 106 and the light fixtures 108.

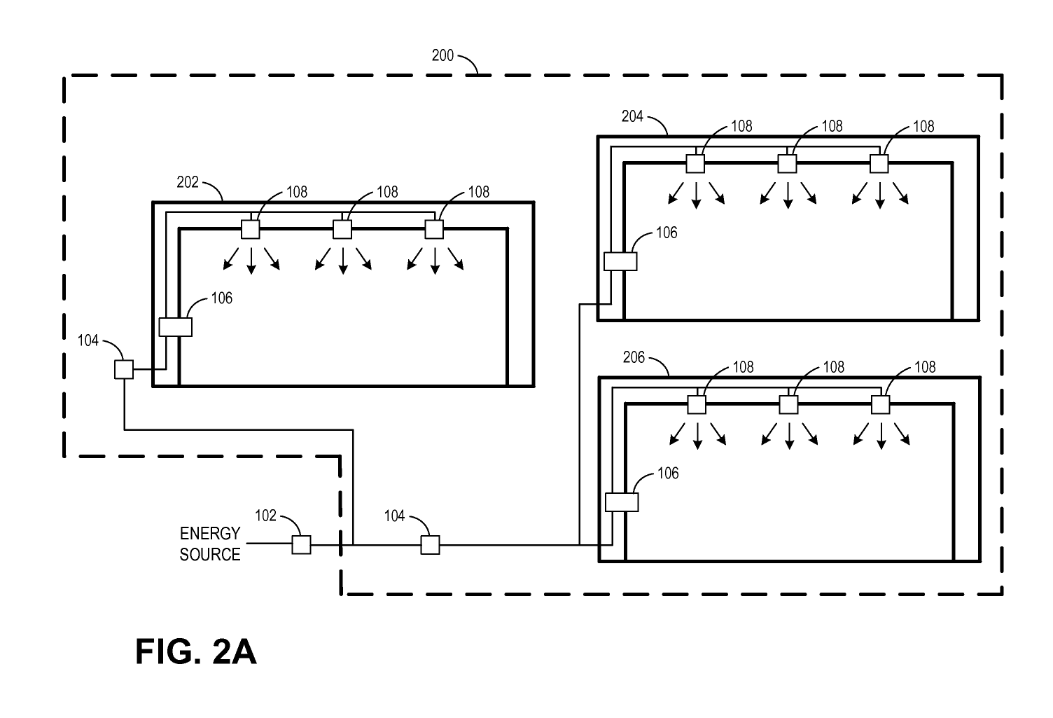

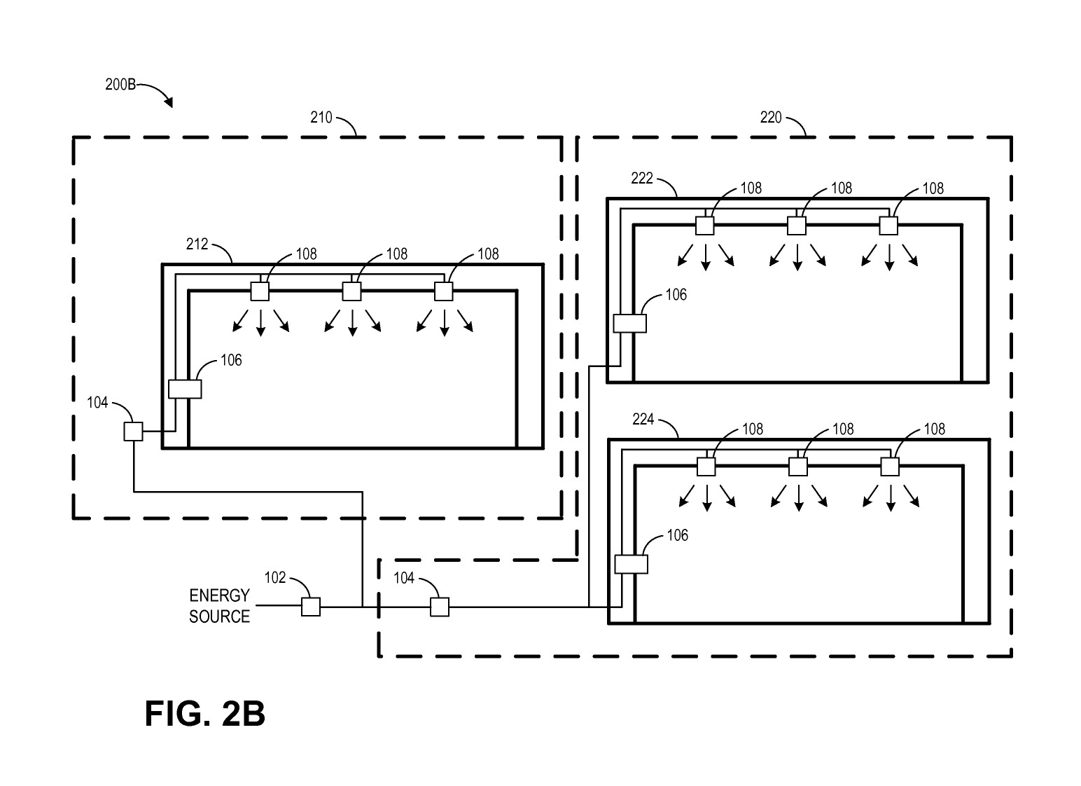

FIG. 2A illustrates a building 200 including a lighting system like the lighting system 100B. The building 200 can include multiple enclosures, such as a room 202, a room 204, and a room 206. Each of the rooms 202, 204, and 206 can include a ceiling, a floor, and multiple walls defining outer boundaries of an interior area the individual room. Each of the rooms 202, 204, and 206 can also include one or more doors or windows (not shown), among other possible room features. One or more of the rooms 202, 204, and 206 can be, for example, a living room, garage, kitchen, bathroom, bedroom, den, dining room, game room, office, closet, warehouse storage, and the like. In some embodiments, one or more of the rooms 202, 204, and 206 can each have an interior area of at least about 100, 250, 400, 500, 750, 1000, 1250, 1500, 2000, 2500, 3000, 5000, 8000, 10k, 12k, 15k, 20k, 25k, 35k, or 50k Feet². One or more of the rooms 202, 204, and 206 can be on the same or different floors of the building and can be above/beneath or to the side of one another.

The building 200 can be supplied electrical energy from the energy source via the circuit breaker 102. The circuit breaker 102 can supply the electrical energy via wires to two AC to DC converters 104 within the building 200. The AC to DC converters 104 can supply the electrical energy to the three switches 106. The switches 106 can each selectively, depending on the state of the individual switch, provide the electrical energy to one or more light fixtures 108 mounted to the ceilings of the rooms 202, 204, and 206. When individual light fixture 108 may receive electrical energy, an illumination source of the individual light fixture can illuminate generally downwards towards the floor as indicated by the arrows in FIG. 2A. For example, the switch 106 that is associated with the room 202 can selectively provide electrical energy and cut off electrical energy to the three light fixtures 108 mounted to the ceiling of the room 202, and thereby control whether at least one illumination source within each of the three light fixtures 108 mounted to the ceiling of the room 202 may be on to illuminate the interior area of the room 202 or off to not illuminate the interior area of the room 202.

One or more of the wires electrically connecting the circuit breaker 102 to the AC to DC converters 104 can be partially or entirely positioned within the walls, ceilings, floors, or other structural components of the building 200 so that the one or more of the wires may be partially or entirely hidden from view of people in the rooms 202, 204, and 206. One or more of the wires electrically connecting the AC to DC converters 104 to the switches 106 can be partially or entirely positioned within the walls, ceilings, floors, or other structural components of the building 200 so that the one or more of the wires may be partially or entirely hidden from view of people in the rooms 202, 204, and 206. One or more of the wires electrically connecting the switches 106 to the light fixtures 108 can be partially or entirely positioned within the walls, ceilings, floors, or other structural components of the building 200 so that the one or more of the wires may be partially or entirely hidden from view of people in the rooms 202, 204, and 206.

The illumination sources of the light fixtures 108 can be used to provide a level of lighting sufficient to enable performance of activities typically performed in the rooms 202, 204, and 206. In some embodiments, the illumination sources in one room, such as the room 202, can together provide in total at least about 500, 750, 1000, 1250, 1400, 1500, 1750, 2000, 2250, 2500, 2750, 3000, 3250, 3500, 3750, 4000, 4250, 4500, 4750, 5000, 6000, 7000, 8000, 10k, 15k, 20k, 30k, or 50k Lumens to light the interior area of the one room. The amount of light provided by the illumination sources in one room can depend at least on (i) the use for the one room, (ii) the floor area of the interior area of the one room, and (iii) the height of the illumination sources of the light fixtures 108 from the floor of the room. For example, if the one room is used as a living room, has a floor area of 200 Feet, and has an illumination source height of 10 feet, the illumination sources in one room can together provide in total about 2000 to 3000 Lumens. The color temperature of the light by the illumination sources in one room can depend at least on (i) the use for the one room, (ii) the floor area of the interior area of the one room, and (iii) the height of the illumination sources of the light fixtures 108 from the floor of the room. In some embodiments, the illumination sources in one room, such as the room 202, can provide light having a color temperature between about 2700 and 6000 Kelvin, such as at 2700, 3000, 3200, 3400, 3600, 3800, 4000, 4200, 4400, 4600, 4800, 5000, 5250, 5500, 5750, or 6000 Kelvin to light the interior area of the one room.

FIG. 2B illustrates multiple buildings 210 and 220 including a lighting system like the lighting system of FIG. 1B. The configuration of the lighting system of the multiple buildings 210 and 220 can be similar to the configuration of the lighting system of the building 200. As illustrated, however, the building 210 and the building 220 can each have a separate AC to DC converter 104 that services the individual building.

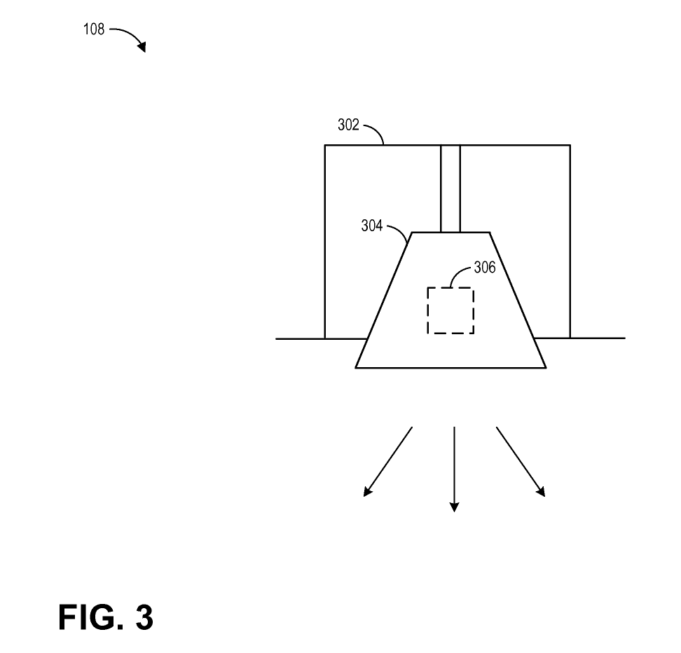

FIG. 3 illustrates the light fixture 108 according to some embodiments. The light fixture 108 can include a fixture housing 302. The fixture housing 302 can be a frame used to support and mount the light fixture 108 and can be made of metal (for example, aluminum) or plastic. The light fixture 108 can include an illumination source housing 304 that includes an illumination source 306. For example, the illumination source housing 304 can be a light or bulb that includes an illumination source 306, such as a p-n junction diode, filament, or gas, that illuminates when supplied with electrical energy of a suitable voltage.

In some embodiments, the fixture housing 302 can weigh about 0.5, 0.6, 0.7, 0.75, 0.8, 0.9, 1, 1.5, 2, 3, or 5 kg. In some embodiments, the fixture housing 302 can weigh less than about 0.5, 0.6, 0.7, 0.75, 0.8, 0.9, 1, 1.5, 2, 3, or 5 kg. In some embodiments, the fixture housing 302 can weigh greater than about 0.5, 0.6, 0.7, 0.75, 0.8, 0.9, 1, 1.5, 2, 3, or 5 kg. In some embodiments, the fixture housing 302 can be about 1, 2, 3, 4, 4.25, 5, 6, 7, 8, 9, 10, 11, 12, 14, 16, 20, or 24 Inches tall or about 1, 2, 3, 4, 4.25, 5, 6, 7, 8, 9, 10, 11, 12, 14, 16, 20, or 24 Inches wide. In some embodiments, the fixture housing 302 can be greater than about 1, 2, 3, 4, 4.25, 5, 6, 7, 8, 9, 10, 11, 12, 14, 16, 20, or 24 Inches tall or greater than about 1, 2, 3, 4, 4.25, 5, 6, 7, 8, 9, 10, 11, 12, 14, 16, 20, or 24 Inches wide. In some embodiments, the fixture housing 302 can be less than about 1, 2, 3, 4, 4.25, 5, 6, 7, 8, 9, 10, 11, 12, 14, 16, 20, or 24 Inches tall or less than about 1, 2, 3, 4, 4.25, 5, 6, 7, 8, 9, 10, 11, 12, 14, 16, 20, or 24 Inches wide.

From the foregoing description, it will be appreciated that an inventive product and approaches for downlighting systems are disclosed. While several components, techniques and aspects have been described with a certain degree of particularity, it is manifest that many changes can be made in the specific designs, constructions and methodology herein above described without departing from the spirit and scope of this disclosure.

Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as any subcombination or variation of any subcombination.

Moreover, while methods may be depicted in the drawings or described in the specification in a particular order, such methods need not be performed in the particular order shown or in sequential order, and that all methods need not be performed, to achieve desirable results. Other methods that are not depicted or described can be incorporated in the example methods and processes. For example, one or more additional methods can be performed before, after, simultaneously, or between any of the described methods. Further, the methods may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount.

Some embodiments have been described in connection with the accompanying drawings. The figures are drawn to scale, but such scale should not be limiting, since dimensions and proportions other than what are shown are contemplated and are within the scope of the disclosure. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

While a number of embodiments and variations thereof have been described in detail, other modifications and methods of using the same will be apparent to those of skill in the art. Accordingly, it should be understood that various applications, modifications, materials, and substitutions can be made of equivalents without departing from the unique and inventive disclosure herein or the scope of the claims.

What is claimed is:

1. A lighting system comprising:
a plurality of fixtures mounted to an enclosure having an interior area, the plurality of fixtures each comprising an illumination source configured to illuminate the interior area, the enclosure comprising a ceiling, a floor, and a plurality of walls defining outer boundaries of the interior area; and
one alternating current (AC) to direct current (DC) converter configured to convert an AC signal received from a circuit breaker to a DC signal, the one AC to DC converter being electrically connected to the plurality of fixtures via a plurality of wires and configured to energize the illumination sources of the plurality of fixtures with the DC signal,
wherein the illumination source of a first fixture of the plurality of fixtures is separated by at least 3 Feet from the illumination source of a second fixture of the plurality of fixtures different from the first fixture, and the illumination sources of the plurality of fixtures are configured to provide in total at least 1400 Lumens.

2. The lighting system of claim 1, wherein the AC signal comprises 120 Volts AC or 110 Volts AC, and the DC signal comprises between 18 Volts DC and 32 Volts DC.

3. The lighting system of claim 2, wherein the one AC to DC converter comprises one transformer configured to operate at 150 Watts.

4. The lighting system of claim 1, wherein the enclosure comprises a first room of a building, and the interior area comprises a floor area of at least 1000 Feet.

5. The lighting system of claim 4, wherein the one AC to DC converter is positioned in a second room of the building different from the first room.

6. The lighting system of claim 1, wherein the plurality of wires is positioned at least in part within the ceiling, and the plurality of fixtures is mounted to the ceiling and comprises metal frames configured to position the illumination sources of the plurality of fixtures to illuminate towards the floor.

7. The lighting system of claim 6, wherein the one AC to DC converter is electrically connected to the circuit breaker via a second wire positioned at least in part within at least of one the ceiling, the floor, and the plurality of walls.

8. The lighting system of claim 1, further comprising a switch configured to activate and deactivate the illumination sources of the first fixture and the second fixture.

9. The lighting system of claim 1, wherein the illumination source of the first fixture is configured to provide at least 700 Lumens.

10. The lighting system of claim 1, wherein the illumination source of the first fixture is configured to illuminate at a color temperature between 2700 Kelvin and 6000 Kelvin.

11. The lighting system of claim 1, wherein the plurality of fixtures is positioned within 60 Feet from the one AC to DC converter.

12. The lighting system of claim 11, wherein the first fixture is positioned at least 10 Feet from the one AC to DC converter.

13. The lighting system of claim 12, wherein the one AC to DC converter is positioned at least 50 Feet from the circuit breaker.

14. A lighting system comprising:
a first fixture mounted to a first enclosure having a first interior area, the first fixture comprising a first illumination source configured to illuminate the first interior area, the first enclosure comprising a first ceiling, a first floor, and a plurality of first walls defining outer boundaries of the first interior area;
a second fixture mounted to a second enclosure having a second interior area, the second fixture comprising a second illumination source configured to illuminate the second interior area, the second enclosure comprising a second ceiling, a second floor, and a plurality of second walls defining outer boundaries of the second interior area;
one alternating current (AC) to direct current (DC) converter configured to convert an AC signal received from a circuit breaker to a DC signal, the one AC to DC converter being electrically connected to the first fixture and the second fixture via a plurality of wires and configured to energize the first illumination source and the second illumination source with the DC signal,
wherein the first enclosure comprises a first room and the second enclosure comprises a second room different from the first room, and the first illumination source and the second illumination source are each configured to provide at least 660 Lumens.

15. The lighting system of claim 14, wherein the first room and the second room are on different floors of a common building.

16. The lighting system of claim 14, wherein the first room and the second room are separated by more than 50 Feet.

17. The lighting system of claim 14, wherein the first room is in a first building and the second room is in a second building different from the first building.

18. The lighting system of claim 14, wherein the AC signal comprises 120 Volts AC or 110 Volts AC and the DC signal comprises between 18 Volts DC and 32 Volts DC, and the one AC to DC converter comprises one transformer configured to operate at 150 Watts.

19. The lighting system of claim 14, wherein the plurality of wires is positioned at least in part within the first ceiling, and the first fixture is mounted to the first ceiling and comprises a metal frame configured to position the first illumination source to illuminate towards the first floor.

20. A system comprising:
a vehicle configured to travel on a roadway; and
a lighting system comprising:
a plurality of fixtures mounted to a ceiling of an interior area of the vehicle, the plurality of fixtures each comprising an illumination source configured to illuminate the interior area, and
one alternating current (AC) to direct current (DC) converter configured to convert an AC signal received from a circuit breaker to a DC signal, the one AC to DC converter being electrically connected to the plurality of fixtures via a plurality of wires and configured to energize the illumination sources of the plurality of fixtures with the DC signal,
wherein the illumination source of a first fixture of the plurality of fixtures is separated by at least 2 Feet from the illumination source of a second fixture of the plurality of fixtures different from the first fixture, and the illumination source of the first fixture is configured to provide at least 660 Lumens.
